(19) United States
(12) Patent Application Publication
(10) Pub. No.: US 2010/0313142 A1
(43) Pub. Date: Dec. 9, 2010

(54) LOCATION BASED SOCIAL NETWORKING SYSTEM

(76) Inventor: DAVID BROWN, KUNA, ID (US)

Correspondence Address: DYKAS & SHAVER LLP, P.O. BOX 877, BOISE, ID, 83701-0877, US

(21) Appl. No.: 12/793,544

(22) Filed: Jun. 3, 2010

Related U.S. Application Data
(60) Provisional application No. 61/183,884, filed on Jun. 3, 2009.

(51) Int. Cl. G06F 15/16; G06F 3/01; G06F 17/30

(52) U.S. Cl. 715/747; 709/204; 707/769; 707/E17.014

(57) ABSTRACT

Presented is a social media method and system which is based upon the physical proximity of subscribers to each other. Use of the social media system and method would allow the user to view other users of the system and method who are in the first user's physical proximity. This is by the use of a WiFi enabled device communicating with a WiFi router to the internet website of the system and method. The WAN IP address of the user is identified and other users are identified who are using the same WAN IP address, and thus are known to be present in the same general vicinity of the first user. Once the user has logged in and been informed of what other users are in the same physical region, the system provides messaging capabilities so that messages can be sent back and forth between users in the same vicinity. This can be users at a convention center, at a restaurant, at an RV park, at a marina, in a downtown region, or other physical locations. The system and method provide modules so that a user may identify what type of interaction he or she wishes to encounter, such as for business networking, for networking at an RV park, for networking at a marina, and for dating purposes.

### PRIORITY/CROSS-REFERENCE TO RELATED APPLICATIONS

This application claims the benefit of U.S. Provisional Application No. 61/183,884, filed Jun. 3, 2009, now pending, the disclosure of which is incorporated by reference.

### TECHNICAL FIELD

This subject matter is generally related to data communications between electronic devices, specifically between a WiFi enabled device and an internet website.

### BACKGROUND

Social networking has revolutionized interpersonal communication. There are a number of social networking sites, each organized with a different purpose and with a different format, but all of them organized to enhance interaction between people. Examples at the current time are: Facebook, Twitter, LinkedIn, MySpace, and other new technologies that are just beginning to gain notice. All of the interactions listed above involve a person contacting a website from a computer, whether it be a laptop, business computer, home computer, and more recently, from a WiFi enabled cell phone. Each of these social networking sites offers different features to enhance the interaction of people and can include sending messages to members, viewing other member's photos, making comments on photos, and many other types of interaction.

None of the prior art of social networking systems provide a social networking experience which is based on the physical location of the user. For instance, in Facebook, a person can be in Iceland and communicating with a person in Brazil and simultaneously interacting with people in the United States. Location is totally irrelevant for a web based social networking site, such as those listed above.

There are no social networking sites which are based on physical proximity of the users. For instance, if a person is in a convention center, there is no social media system which would allow him to identify and interact only with people who are in that convention center. Similarly, people who camp, travel or live in recreational vehicles (RV's) may want to interact with other RV enthusiasts who are camped at the specific campground where that person is camped.' For instance, they might want to see all of the people camped at the campground, and if they see someone with an interesting biography or interesting preferences, they may want to sent that person a message or even follow that up with meeting that person and sharing a meal with them or traveling to the next destination together. Similarly, people who are living on a boat, or traveling by boat, may be in a marina and may want to view other people who are in the marina and who may have similar interests. Each of these are location based, and would be social media based upon the users being proximate to each other. This can be accomplished by use of WiFi enabled devices such as laptops, cell phones, and smart phones; with all phones being produced these days being equipped with WiFi capabilities. By the use of the WiFi features of WiFi enable cell phones and laptops, the location of a system user be identified by the WAN IP address of the WiFi router that is accessed by the user. A system can easily tell what other subscribers to the system are simultaneously using the same WiFi router or a nearby router, and are thus in the same physical proximity to other users of that router.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Presented is a location based social networking system, which also has the ability to target advertising to a particular cell phone user in a particular location.

The system is based on the use of WiFi signals by a person using a cell phone, a laptop, a PDA, or other WiFi enabled device, in order to connect to the internet. A person signs up with the online social media service and during the sign-up process enters certain information about himself/herself. This can include information about what content he wants to receive or what information he wishes to receive from the system. This information could be product information for products he is interested in. It could also be networking information, or it could be personal content, such as for dating or social networking purposes. The database of the social media system stores personal information and preferences from all of the users of the network.

For a person who is primarily interested in the dating or social networking capabilities of the network, they would particularly want to list their age, where they live, and their intention such as: male seeking female, female seeking male, etc., and their interests, which might be scuba diving, karate, tennis, horses, etc. Other personal information is also entered, including but not limited to city, state, biography, motto, goals, and others.

For a person who is more interested in the business related networking capabilities of the system, they would list information such as their occupation, a specialty within their occupation, where they are located, what their company name is, and what type of consultation they might be interested in giving or receiving.

When a person enters a region or a building—with examples being a coffee shop, a campground, a marina, an airport, a convention center, a hotel, a store, or a mall—by use of this system, a user can find out what subscriber individuals are present in the vicinity who are registered with the service and who have matches to the user's requested information. For instance, when a male user enters a coffee shop, if the male user is primarily interested in using the system for meeting compatible females, by using his cell phone or other WiFi enabled device, he can find out which, if any, of the system's female users are physically present in that coffee shop. While he is accessing the database, he can also view pictures of the users which are present and information such as their age, location, and interests.

Another example might be when a user is at a convention in a town distant from his hometown. By accessing the database using his cell phone, for instance, he can find other people who are present in the convention in a town distant from his hometown. By accessing the database using his cell phone, for instance, he can find other people who are present in the convention center who are from the same hometown, who have the same interests in scuba diving, who work in the same industry as he, who are members of a fraternal or service club he is also a member of, who may want to receive a consultation in some specialty in which he would be interested in giving a consultation, or who provide a service for the industry in which he works. He can see a picture of that person and initiate an email conversation with that person, or call them on his cell phone.

A third example of how this system could be used is in a situation in which the user enters a mall or a store. By accessing the database through his cell phone, a PDA, laptop, or other WiFi enabled device, the user's location would be identified and members of the networking service could send ads and specials to his cell phone. Thus, when the user entered a mall, he could check for ads and specials. Those stores which were physically located at that mall could send him specials which pertain to some of his interests. For instance, when he arrived at the mall, he might receive notice of a sale being conducted by the scuba diving shop, or the saddle shop, or what running shoes are on special, or other ads which would be placed by the owners of stores and would be sent to users of the networking system who were physically present near the store. These ads would be tailored according to the interests he has specified, such as scuba diving, or horseback riding, or running.

The system works when the user accesses the internet through his cell phone. The user logs on to the server using a name and a password. He has previously entered information about his account on the database of the system, including his user name and password. The WAN IP address, which is the identified with the WiFi router he is accessing, is then detected by the networking system. The database of the networking system compares the users WAN IP address to other users who are currently accessing the same or a nearby WAN IP address. It looks for a match in such categories as location, module, user preferences, and user privacy settings. The user can define his preferences such as: that he wishes to meet single women, or that he wishes to receive ads about running shoes.

Upon signup, he would identify a module he is interested in, with the modules grouped according to the primary interest of the user. Modules can include the dating module, a business networking module, a module for a specific group, such as RV users or boat owners, or any subgroup of subculture of people. He can also set his privacy settings so that he can view the information about the other users who are present, but his personal photograph and other information is not visible to others. In one variation of this plan, an upgraded subscription type would allow the user to view other people's information, without disclosing his, or would delay disclosure of his information to other user's for a period of time. The end result of the user accessing the database of the social media system is that the image, screen name, biographical information, or product information of users who are physically present and using the same or a nearby WAN IP address is sent to the user's device in the form of an output page or personal page, whether that device is a cell phone, laptop, or PDA. Email or text exchanges between users with compatible privacy settings and selection criteria are then available as an option.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a diagram showing the social media method and system of the social media system in use in a restaurant as an example.

FIG. 2 is a flowchart which shows the general steps of the system performed to acquire data about a customer and to present data about active users.

FIG. 3 is a flow chart of the steps of the method of one aspect of the disclosed method.

FIG. 4 is a diagram showing the interactions between the WiFi enabled device, the system, and the WiFi router.

FIG. 5 is an example of a subscription page.

FIG. 6 is an example of a profile page.

FIG. 7 is an example of a module selection page.

FIG. 8 is an example of a profile data entry page.

FIG. 9 is an example of a profile data entry page.

FIG. 10 is an example of a profile data entry page.

FIG. 11 is an example of a profile data entry page.

FIG. 12 is an example of a profile data entry page.

FIG. 13 is an example of a profile data entry page.

FIG. 14 is an example of a profile data entry page.

FIG. 15 is an example of a profile data entry page.

FIG. 16 is an example of a profile data entry page.

FIG. 17 is an example of a profile data entry page.

FIG. 18 is an example of a profile data entry page.

FIG. 19 is an example of a profile data entry page.

FIG. 20 is an example of a profile data entry page.

FIG. 21 is an example of a profile data entry page.

FIG. 22 is an example of a profile data entry page.

FIG. 23 is an example of a user log in page.

FIG. 24 is an example of an output page.

FIG. 25 is an example of an output page with the user showing unread messages.

FIG. 26 is an example of a user's contact page.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

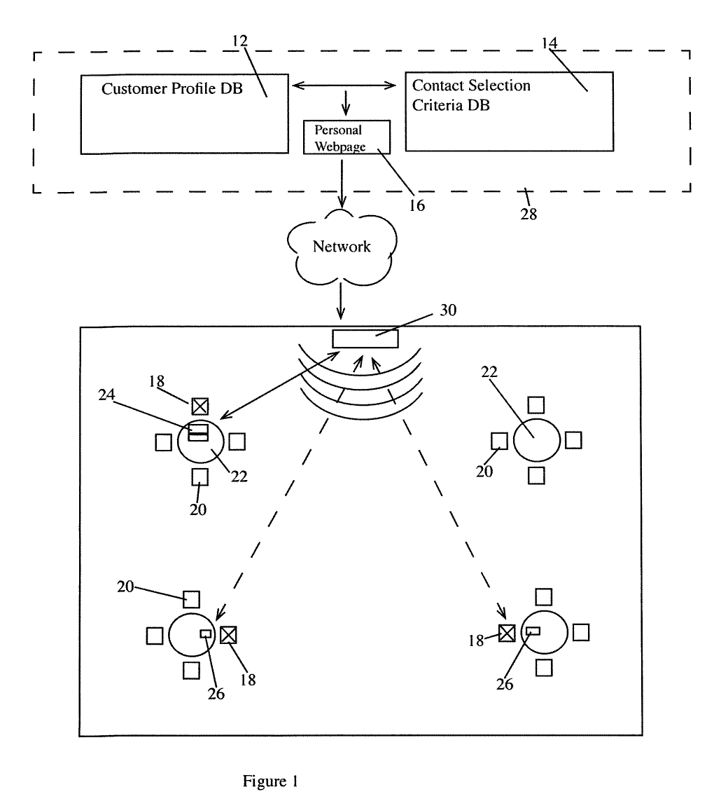

Several embodiments of the preferred embodiment are shown in FIGS. 1-26.

FIG. 1 shows the social networking method 10 of the disclosed social media method as it is used in a particular location. FIG. 1 shows a customer profile database 12, a contact selection criteria database 14, and a personal web page 16. These are accessed by a user 18 and may also be referred to as a customer. In FIG. 1, the users 18 are indicated by an X, in a representation of a table setting with four chairs 20, around a table 22. One user 18 is shown with a laptop computer 24 and other users are shown as having access to a WiFi enabled phone 26. Using the WiFi enabled phones 26 or the laptop 24, the users 18 communicate with the system 28 to access their personal web page 16.

Displayed on their personal web page 16 will be those users 18 which are simultaneously accessing the same WiFi router 30, or the search may be optionally expanded to include nearby WiFi routers. Each of the three users shown in FIG. 1 would have a personal web page 16 which was unique to that user, and would display only those users which are utilizing the same WiFi router at the same time, and which have compatible selection criteria as the user 18, and optionally module selection.

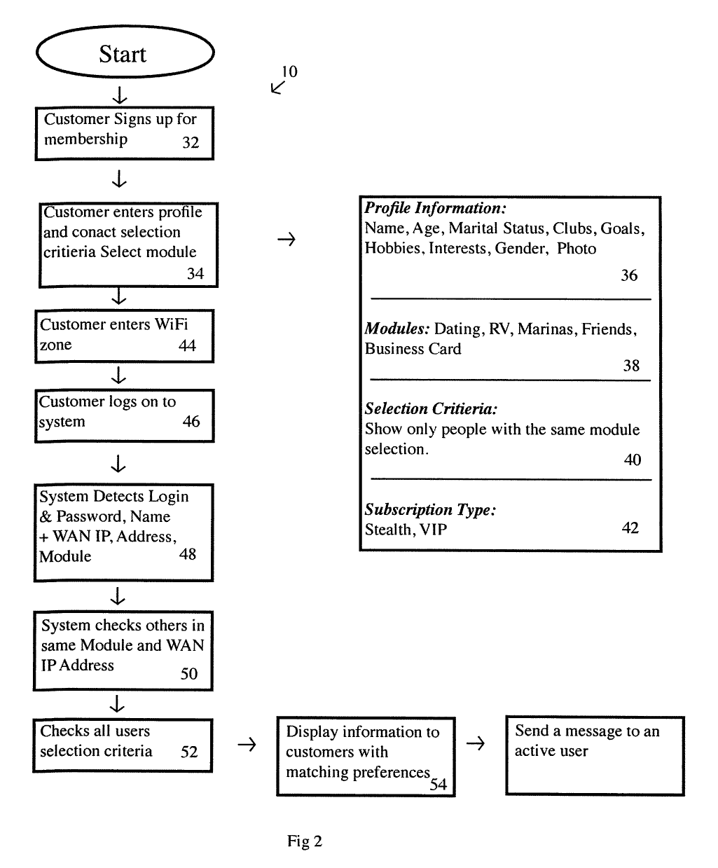

FIG. 2 shows a logic diagram of how the social networking method 10 works. The initial step for a customer 18 is to sign up for membership at the box 32. The customer may sign up for membership using a WiFi enabled device such as a laptop of cell phone, or may log on to the internet using any kind of a computing device, such as a desktop computer. In the process of logging in, the customer/user enters profile and contact selection criteria which are entered into respective databases for that information. The user also selects at least one module in which he is interested in participating. The customer profile data entry and module selection step is shown in box 34.

Profile information is entered at block 36 and includes personal information such as name, age, marital status, clubs the user is involved with, goals, hobbies, interests, gender, a photo, and other information appropriate to the modules selected, that the user might want to share with other members participating in the social networking method. At least one module is selected in step 38 and includes the type of associations the user wants to interact with. For instance, the user could be interested in using the site for dating purposes. Another user might be interested in using the site to interact with people who might be staying at the campground at which the first user's RV is currently visiting. Other locations which might provide a shared WiFi router in a location for users might include: marinas for boat travelers, a college campus for college students, building residents, and users who want to make associations based upon business contacts and interests. At block 40, the user enters selection criteria which specify certain criteria which are of interest to the user, and which may rule out communication with certain active users. By “active user” it is meant anyone who is physically present simultaneously at a certain WiFi router in order to interact with other users of system who are physically present and using the same WiFi router. Optionally, the system may be instructed to view active users at nearby WiFi routers, in certain situations where a number of WiFi routers are active in close proximity.

For instance, if a person has signed up and indicated that he or she wishes to use the dating module, he may enter selection criteria, such as, that he only wants to have information displayed by persons of a certain sex, within a certain age range, persons who show a residence in a certain city, or only persons who indicate a selected interest, such as scuba diving. By entering this type of selection criteria, the social networking method 10 and the associated system 28, selects which active users to display to a signing-on user, and which data fields to display. A fourth selection that the user makes in signing up for a subscription is a subscription type he is interested in. For example, one subscription type might be called the stealth subscription, in which the user may view other active user's information, but they may not see him, or may only see his information after a certain period of time. Another type of subscription might be termed the VIP subscription, in which the user with the VIP subscription has enhanced search capabilities available to him, and can search by any of the criteria, such as in multiple modules to view any customers that are presently signed in and using the same WiFi router as he is, or on nearby or selected WiFi routers.

After the profile information is saved and the subscription is started, the next interaction with the customer occurs when the customer enters a WiFi enabled zone, shown at block 44. The WiFi zone is a physical area surrounding a WiFi router, and its size is determined by the range of the WiFi router. The WiFi router could be located in any physical structure, such as a convention center, a sports bar, a coffee shop, a school, college or university, a sports stadium, an RV park, a marina, a downtown core, an apartment building, an airport, and other typical places where WiFi routers are positioned.

Once the customer has entered a WiFi zone, he may log in to the system if he chooses, which is shown in block 46. To log in to the system, the user accesses the system web page by use of his WiFi enabled device, and logs in, using such conventional protocol as a user name and password. At step 48, the system detects the user's login and password, and from that information, determines the user's name, and also identifies the user's WAN IP address. They system also detects the module that the user has selected for participation, which could be the dating, RV users, marina users, friends, or the business card modules which are shown in FIG. 2, or any number of other modules which are established by the system and which the customer may choose to access during the sign in process. At block 50, the system checks for other users which are active in the same module and which are using the same WAN IP address as the user who is signing on. In block 52, the system further identifies selection criteria that the user has established, which may include selection criteria that other users have specified as far as what type of user the information is to be shown to. At Block 54, an output or personal web page is created, and displayed to the user. This personal web page is unique to each user, and would show him those active users who are currently using the same WiFi router where the user is located, and who are participating in the same module as the user who is signing on and which have compatible selection criteria with the user who is signing on. The signing-on user may choose to send a message to another active user who is visible on his personal web page, and initiate contact with other nearby users through the social networking system. The users would communicate with each other through the web page of the system via messaging through the WiFi router, or could communicate directly by making a phone call.

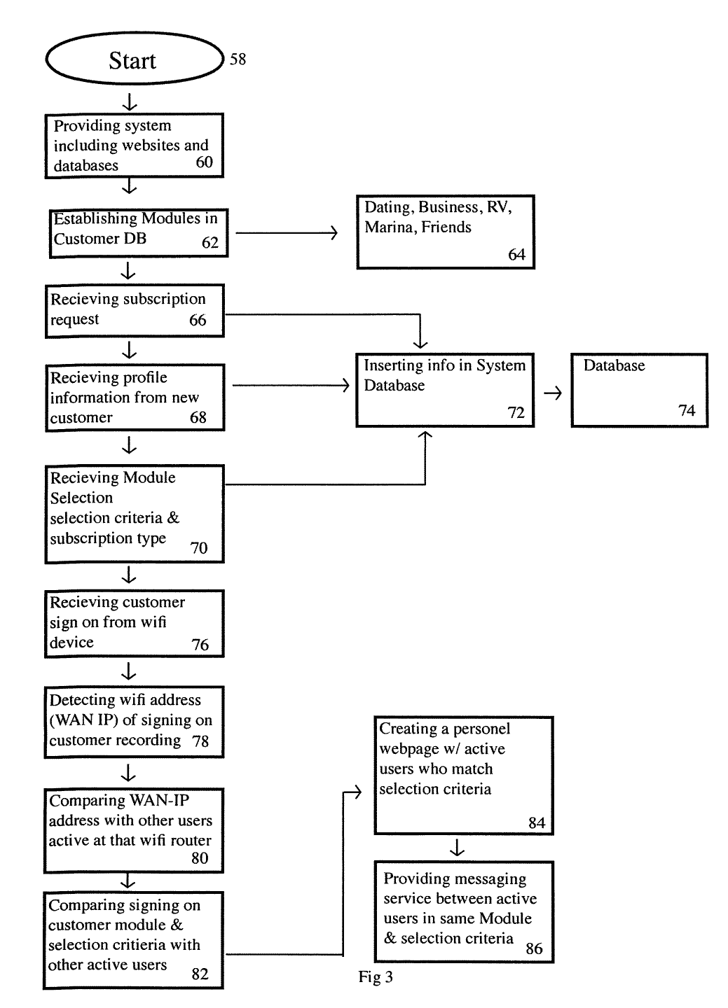

Shown in FIG. 3 is the method of the disclosed social media method , starting at block 58, where a user may begin the process of signing up for the social networking method and using it. Step 60 is the step of providing a social networking system, including a website and various associated databases. At block 62 is shown the step of establishing modules in the customer database. The modules define the type of social interaction a customer is interested in pursuing. For instance, the customer may be interested in using the social networking site for dating, for business, or for interacting with people of a particular interest who would be likely to gather at a certain physical location. This could be campers at an RV park, boaters at a marina, friends at a university, or many other groupings. The user does not define the groupings or modules, and the modules are not created based on the users present at an event. The modules are created by the system administrator, and offered for selection to users. Some examples of modules the customer may choose from are shown in block 64.

Block 66 is the step of receiving a subscription request from a new customer. The subscription request is followed by the step of receiving profile information from the new customer shown at block 68, receiving module selection, and selection criteria, and subscription type at block 70; inserting all of that customer specific data into a system database at block 72, with the database shown in block 74. At block 76, is shown the step of receiving the customer sign-on from a WiFi enabled device. This would occur when a customer walks into an area where a WiFi router is present, and he activates his WiFi enabled device, such as a cell phone, then logs on to the system website using his password and username. The next step is detecting the WiFi address, also called the WAN IP address, of the user at block 78. The next step after that is comparing the WiFi address of the customer who is logging on to other customers who are simultaneously using the same WiFi address or WAN IP address, which indicates they would all be using the same WiFi router and are thus in the same physical location. The next step is comparing the sign on information with the customer's user profile, module, and selection criteria with other users who are active at that particular WAN IP address, or optionally a near by one. The next step is creating a personal web page which shows the active users who are using the signing-on user's WAN IP address and who match the selection criteria of the signing-on user, including module and selection criteria.

The next step is providing a messaging service at block 86, between active users in the same module and with compatible selection criteria, who are using the same WiFi router as the signing-on user. Using the message service of the system, one user may initiate contact with another user and two or more users can proceed to have a conversation, knowing that the user they are talking to is present in the same physical location.

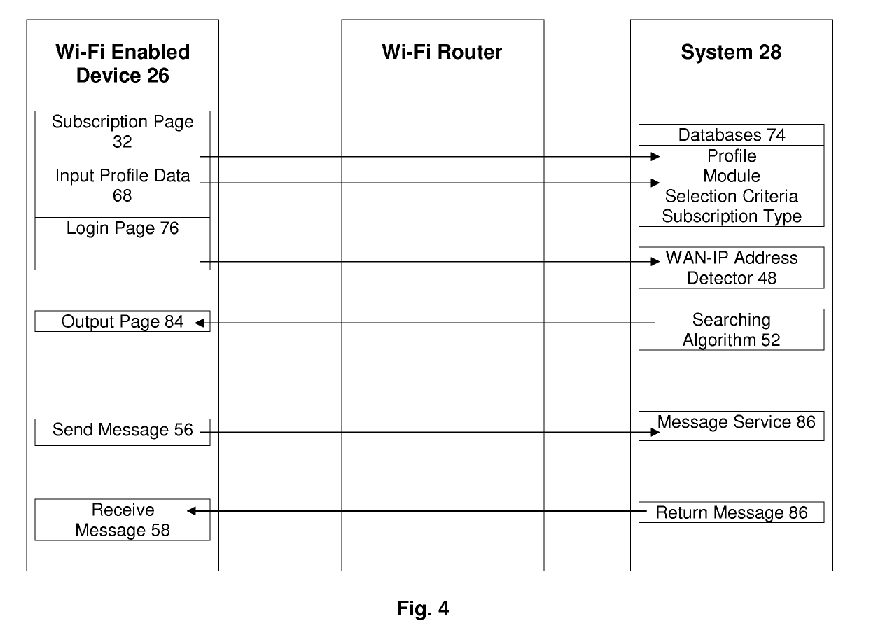

FIG. 4 shows the system of the disclosed social media system and how they work together. As shown in FIG. 4, all of the communication between the user's WiFi enabled device 26 and the system 28, go through the WiFi router 30. Available to the user on the WiFi enabled device is a subscription page 32. The user enters information at the subscription page which is entered into database 74, which can be one database with numerous fields, or can be separate databases. Information entered into the database includes profile information such as name, age, photo, module information, which is the module the user intends to participate in, which can be a dating module, business module, or other preselected modules which are available for the user to choose from. Other information at the subscription page includes selection criteria with which the user may identify criteria for returning information about other users to him, and he may also identify which of his personal information he wishes to be displayed to other active users.

The user will also find in the environment of the WiFi enabled device, a login page, which he utilizes to log in to the system when he enters into a WiFi active zone, and when he wishes to participate in the system. At the log in page, the user enters a user name and password, or other similar identification, which is sent to the system and picked up by a WAN IP address detector 48. The WAN IP address detector 48 identifies the physical location of the user, and also identifies what other users are actively using the same WiFi router as the signing-on user. The searching algorithm 52 also identifies, among the active users who are on the same WiFi router as the signing-in user, which of them have criteria which match the selection of the user. Those users who are active on the same router and who meet the selection criteria of the user signing in, have information that they have specified from their profile sent to the signing-in user in the form of an output page 84. The output page 84 would typically list those subscribers to the service who are present in the same physical location as the signing-in user, and who have criteria which match the selection criteria of the signing-in user. The signing-in user may then elect to send a message 56, which is routed to the message system 86 of the system 28. The user to whom the message was sent may then send a return message 86 which the signing-in user receives at 58.

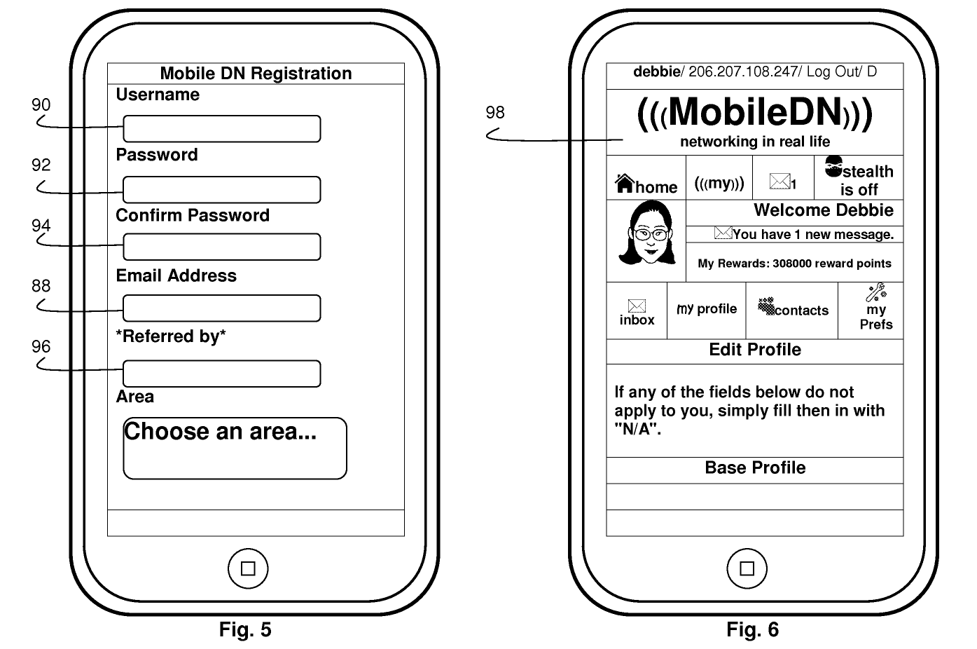

FIG. 5 shows a typical registration or subscription page 88 which a new user would use to begin the sign up process. On the screen, the user would enter a user name 90, confirm the password 92, enter an email address 94, and enter a customer name in the “referred by” section, if appropriate.

FIG. 6 is an example of a profile page 98 in which a user enters profile information and may edit that profile information.

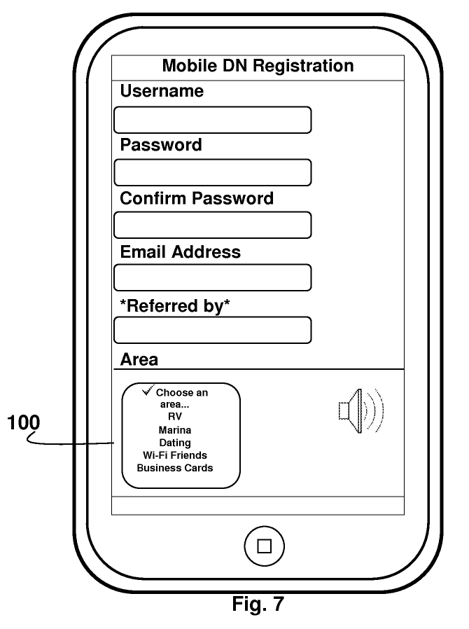

FIG. 7 is a module selection page 100, in which some of the possible modules are shown in a drop down menu. The modules shown are for RV, marina, dating, WiFi friends, and business cards. Other modules can be established which reflect groupings of individuals with a common interest.

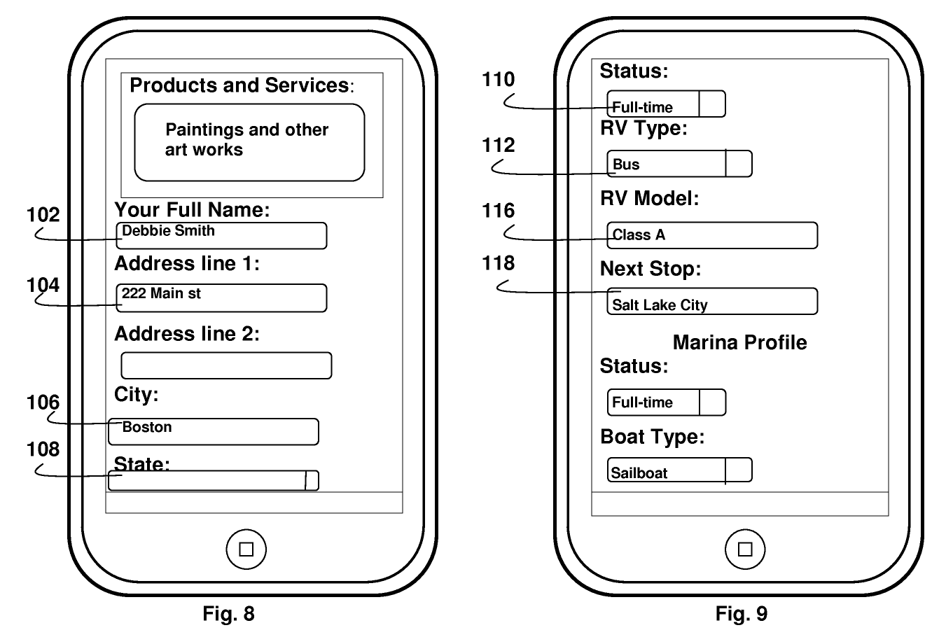

FIG. 8 is an example of a page showing the profile information from a hypothetical user, Debbie Smith. Shown are the user's full name 102, the user's address 104, the user's city 106, and the user's state 108.

Shown in FIG. 9 is more profile information which may entered by a user who may have signed up for the RV module. As examples of information that might be entered that are relevant to a particular group of people in a module, shown is the status 110 of the user, which refers to if the status of whether the person is a full time RV resident, or is vacationing in the RV, or other conditions of their use of the RV. Shown in block 112 is the RV type which the user would specify that might be a bus, class A, a pickup camper, or whatever is relevant. Shown in block 114 is the class of RV such as Class A. Shown in the destination block 116 is the next stop on the RV user's route. Similarly, if the person was in the marina module, information such as the status and type of boat would be entered, as shown in the bottom of FIG. 9.

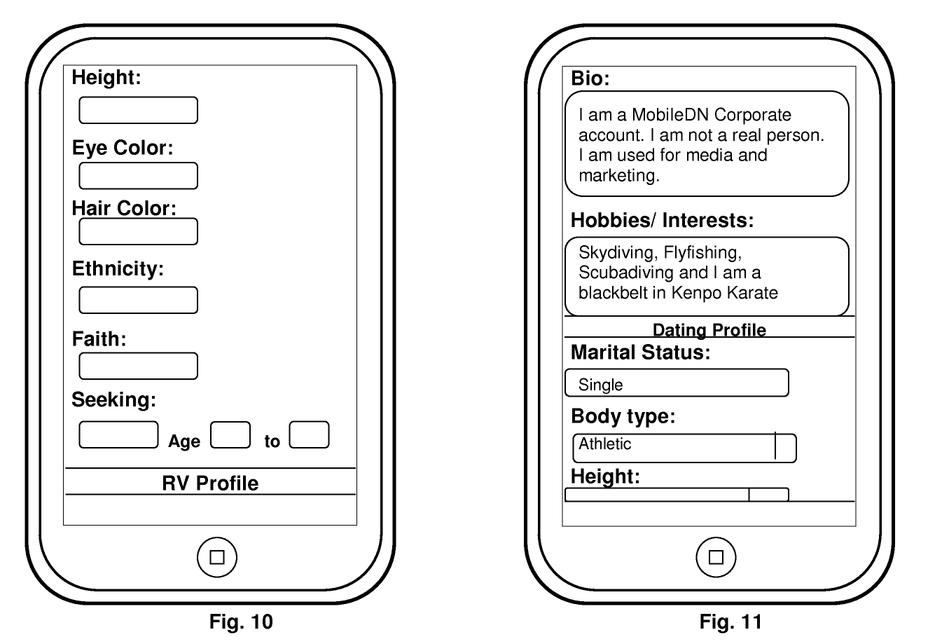

Shown in FIG. 10 are examples of the type of information that might be entered as profile information, some of which might be shared with other users of the network. FIG. 10 includes further information such as information on bios and hobbies, marital status, body type, and height, as examples of other profile information.

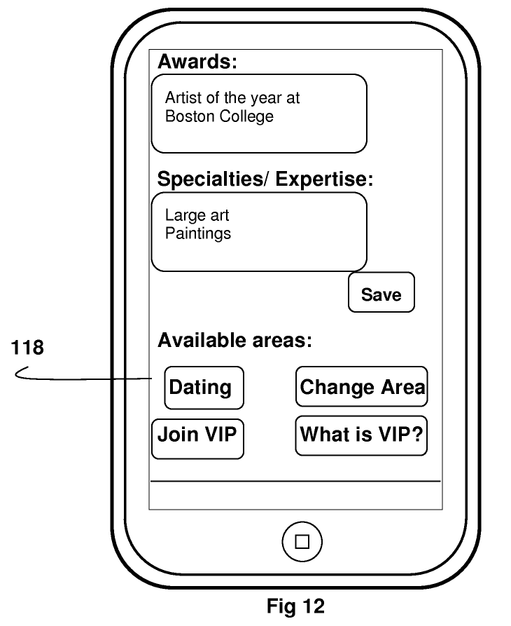

Shown in FIG. 12 are further examples of information which may be entered as profile information, and stored in the database of the system. These can include awards that the user is proud of, or specialties and areas of expertise, such as the notation, “large art paintings.” Shown in FIG. 12 is the subscription type selector in which the user may select an enhanced subscription, which would give him more optimized searching capabilities, for instance, or give him/her the ability to view other people's profile information before than can view the user's. Examples of enhanced subscription options include a VIP option or stealth option, which are one of many examples of subscription types.

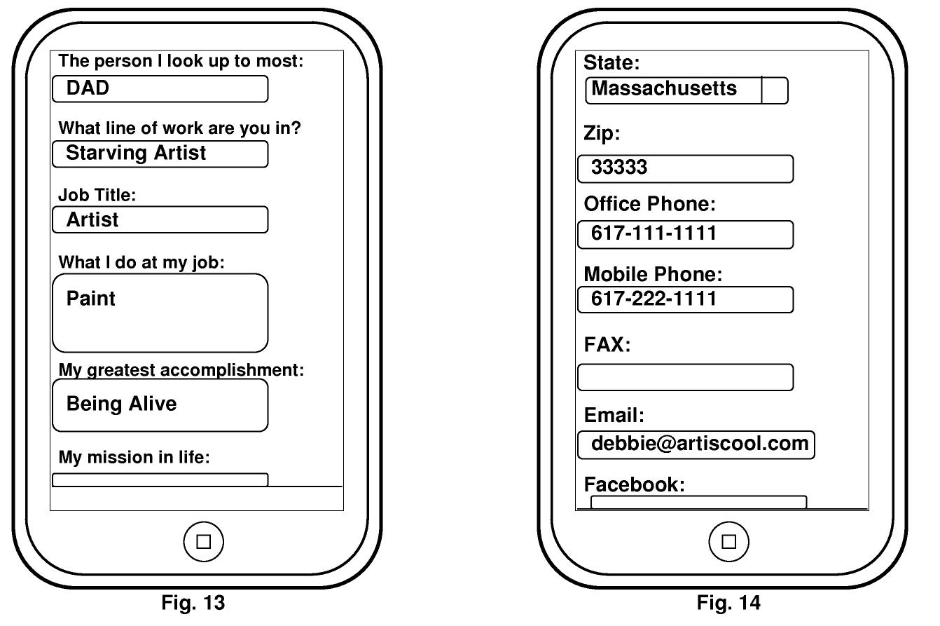

FIG. 13 shows additional information which may be entered as profile information, including the person the user looks up to the most, the type of work the user is in, the job title, what he does at his job, and his greatest accomplishment.

Shown in FIG. 14 are additional base profile information such as the user's zip code, office phone, mobile phone, fax, email address, and/or Facebook address.

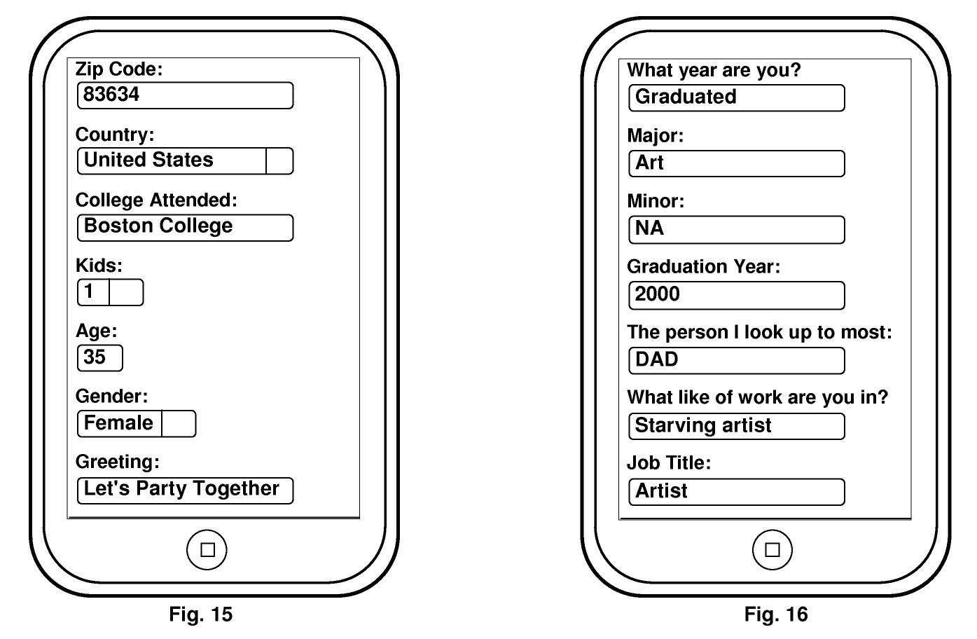

Shown in FIG. 15 is additional profile information which may be entered by a subscriber which includes one or more colleges attended, the number of children, the user's age, the user's gender, and a greeting or slogan.

FIG. 16 shows additional profile information that a subscribing user may enter, including, their year in college, their major, their minor, their year of graduation, the person they looked up to the most, the line of work they are in, and their job title.

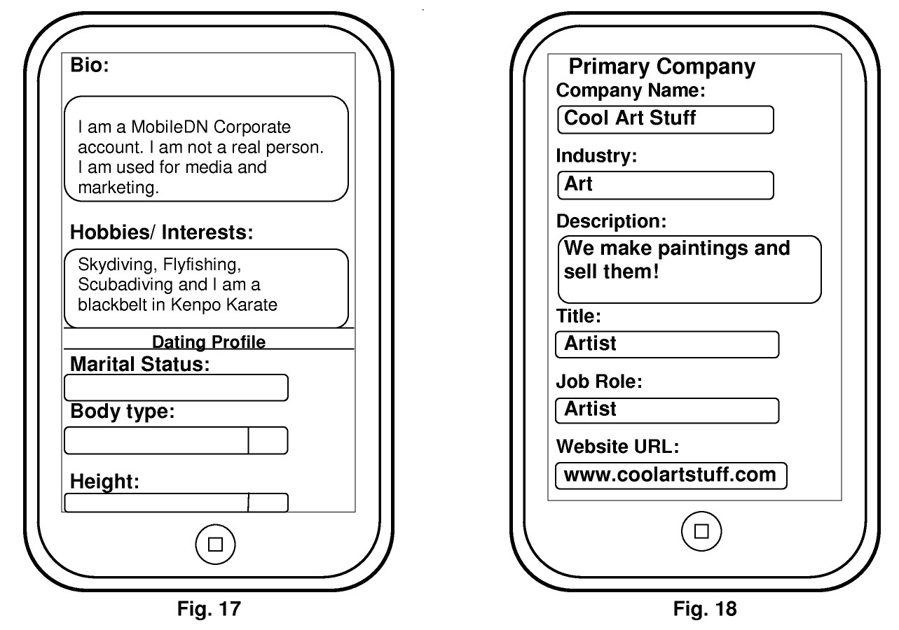

FIG. 17 shows additional information which may be entered a user's profile, such as, a short bio, hobbies and interests, and dating profile information such as marital status, body type, and height.

FIG. 18 shows additional profile information which may be entered by a subscribing user, such as, their company name, the industry they work in, a description of what their company does, the title and job role of the subscriber, and the company website.

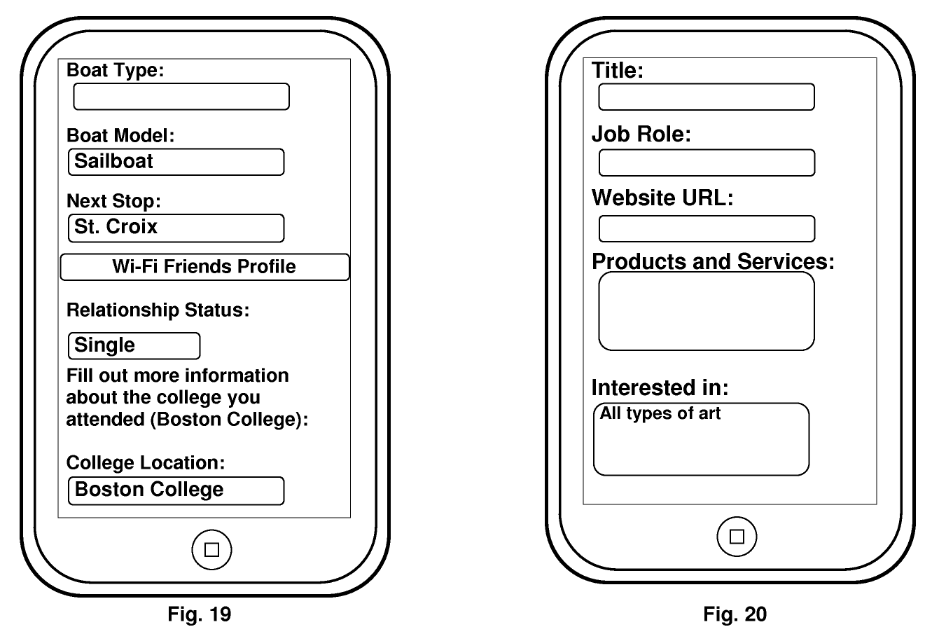

FIG. 19 shows additional information which may be entered relating to the boating or marina profile, such as the boat model and the next stop in the travels of the boater. Also shown are fields for entering information in the Friends module or profile, such as relationship status and college information.

Shown in FIG. 4 is additional information which a subscriber may identify when filling out a profile, including entry points for a job title, the job role, company web site, the products and services that are offered by the company, and the interests of the user.

FIG. 20 shows additional information which may be entered in the customer profile information, such as, the user's mission in life, user's favorite sports teams, what the user would do if he/she had a million dollars, and the user's business card information.

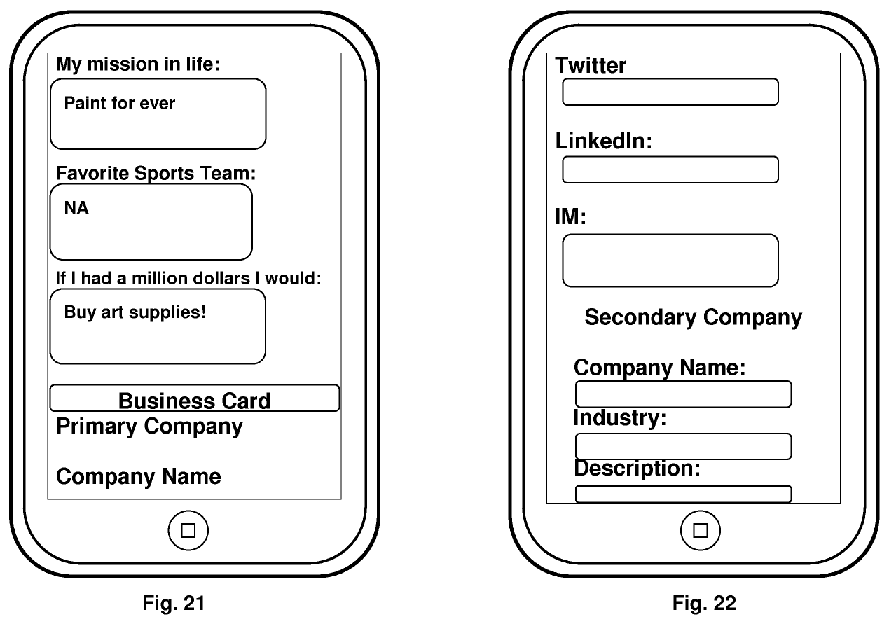

Shown in FIG. 22 is information which may be entered about the user's Twitter account, the LinkedIn account, an IM field, and information about the user's secondary company.

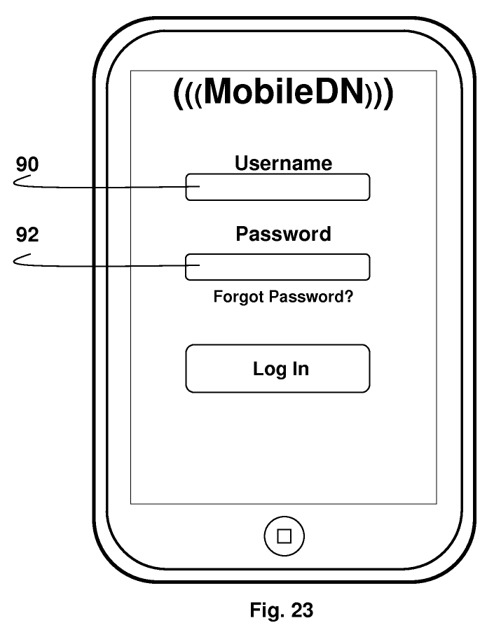

FIG. 23 shows an example of a system log in page, with blanks for the user name 90, the password 92, and a field for log in information.

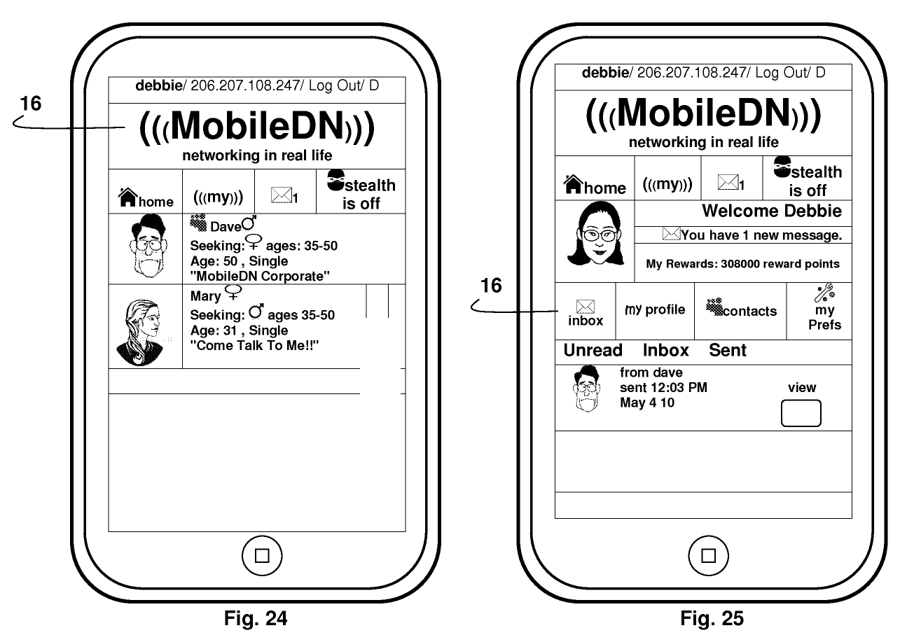

Shown in FIG. 24 is an output page 16 which is sent to the user's WiFi enabled device and which shows the subscribers who are currently present at a given location. In this example, Dave is shown as being present and seeking females, ages 35-50. Dave is age 50, single, and identifies himself as a Mobile DN corporate. Mary is also identified as being present, and indicates that she is seeking males, age 30-45. She is age 31, single, and identifies herself with the phrase, “Come talk to me!!”.

FIG. 25 is an example of an output page, which would be directed at Debbie, and output page 16, which would be directed at Debbie, and which contains a message from Dave. From this page, the user, Debbie, could view the message from Dave and choose to respond or not.

Shown in the output page 16, which has been sent to the user Debbie, by the system, is an inbox which show in the unread or sent messages, a My Profile section which may be edited by Debbie, a My Contacts section which lists subscribers who have been identified by Debbie as friends, and a My Preferences section which allows Debbie to change information such as email address, password, and other personal profile information.

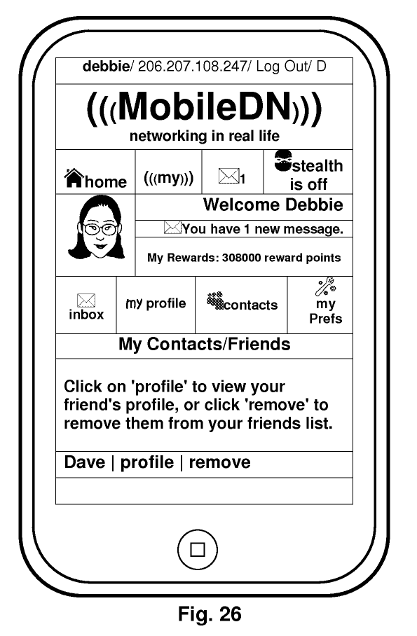

Shown in FIG. 26 are contacts which the user Debbie has placed into the My Contacts section. These are lists of people who Debbie has identified as contacts she wants to keep track of, and may or may not be present at the location of Debbie's current sign-on.

While certain exemplary embodiments are shown in Figures and in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A social networking method comprising:
providing a customer database structured to received customer profile information and contact selection criteria;
establishing modules in said customer database, based on user interest;
receiving a subscription request from at least one customer via an internet connection;
receiving as part of said subscription request, customer profile information, module selection, and contact selection criteria from a plurality of customers;
inserting said customer profile information, and contact selection criteria into said customer database;
receiving customer sign-on information including a user name and password, from at least a signing-on customer, from a WiFi enabled device in possession of said signing-on customer, thru a WiFi router;
detecting a WAN IP addresses for said signing-on customer;
recording said WAN IP address information for said signing-on customer in said customer database;
comparing said WAN IP addresses of customers active in contacting WiFi routers, and returning those customers currently active at the same WiFi router as said signing-on customer;
comparing contact selection criteria of customers active at the same WAN IP address, and if selection criteria of active customers at the same WiFi router match, sending specified customer profile information of active customers to said first customer and said second customer in the form of an output page readable on said signing-on customer's WiFi enabled device.

2. The social networking method of claim 1 which further comprises the step of the user selecting a module for participation, with said module containing users with a similar interest as other users.

3. The social networking method of claim 2 in which said step of the user selecting a module further comprises the option of selecting a module set up for customers interested in social interaction with other customers for purposes of dating.

4. The social networking method of claim 2 in which said step of the user selecting a module further comprises the option of selecting from a plurality of modules set up for customers interested in social interaction with other customers, with said modules provided based on common business or social interests.

5. The social networking method of claim 2 in which said in which said step of the user selecting a module further comprises the option of selecting more than one module for interaction.

6. The social networking method of claim 1 which further comprises the step of selecting a subscription type, with the subscription type defining a user's options for viewing other users profile information.

7. The social networking method of claim 6 in which the step of selecting a subscription type further comprises a user defining which if any of his own profile information is visible to other users, based on subscription type.

8. The social networking method of claim 6 in which the step of selecting a subscription type further comprises a user defining which if any of other users profile information is visible to himself, based on subscription type.

9. The social networking method of claim 6 in which the step of selecting a subscription type further comprises selecting which if any of other users profile information is visible to a user, and which if any of his own profile information is visible to other users, based on subscription type.

10. The social networking method of claim 1 which further comprises the step of a first user sending a message to a second user who is currently accessing the same WiFi router as the first user, and receiving a message from said second user, with said message sent via said WiFi router to said system, and back through said WiFi router to said users.

11. A social networking method comprising:
providing an online social networking page, for displaying users based on simultaneous use of a WiFi router, with said social networking page interactive with a customer database structured to received customer profile information and contact selection criteria, and configured to display selected use information to a first customer only if said users are simultaneously using the same WiFi router as said first customer and only if said users have selection criteria that match those of the first customer;
establishing modules in said customer database, based on user interest;
receiving a subscription request from at least one customer;
receiving as part of said subscription request, customer profile information, module selection, and contact selection criteria from a plurality of customers;
inserting said customer profile information, module selection, and contact selection criteria into said customer database;
receiving customer sign-on information including a user name and password, from at least a first and a second customer, from a WiFi enabled device in possession of said first and said second customer, thru a first WiFi router at a time when both said first and said second customer are accessing said first WiFi router;
having a system computer detect WAN IP addresses for said at least a first and a second customer;
recording said WAN IP address information for said first and said second customer in said customer database;
comparing said WAN IP addresses of customers active in contacting WiFi routers, and returning those customers currently active at the same WiFi router;
comparing contact selection criteria of customers active at the same WAN IP address, and if selection criteria of active customers at the same WiFi router match, sending specified customer profile information of active customers to a first customer in the form of an output page;
providing a messaging service to said customers, so that a user may send a message to a user on his output page, and receive a response to said message from another user, with said messages sent via said WiFi router to said system, and back through said WiFi router to said users.

12. The social networking method of claim 11 which further comprises the step of selecting a subscription type, with the subscription type defining a user's options for viewing other users profile information.

13. The social networking method of claim 11 in which the step of selecting a subscription type further comprises a user defining which if any of his own profile information is visible to other users, based on subscription type.

14. The social networking method of claim 11 in which the step of selecting a subscription type further comprises a user defining which if any of other users profile information is visible to himself, based on subscription type.

15. The social networking method of claim 11 in which the step of selecting a subscription type further comprises selecting which if any of other users profile information is visible to a user, and which if any of his own profile information is visible to other users, based on subscription type.

16. A social networking system, comprising:
a web site available for interaction with customers from at least one WiFi router, said system comprising:
at least one database, with said database configured to store customer profile information;
a subscription page configured for sending to a new customer, with capability for the customer to enter profile and searching criteria information in a subscription entry;
a login page configured for sending to a signing-in customer, with capability to receive a username and password;
a WAN IP address detection module, for determining the WAN IP address of a signing-on user;
a searching algorithm which searches said at least one database and selects customers at the same WAN IP address as said signing-on user, and with searching criteria that match those of said signing-on user;
an output page listing subscribers presently using the same WAN IP Address as said signing-on user and having matching selection criteria as said signing-on user, with said output page listing selected profile information of those subscribers selected; and
a messaging system configured for a user to send a communication to a listed subscriber present at a subscriber's particular WAN IP Address, through said WiFi router and through said system.

17. The social networking system of claim 16, which further includes modules and a module selection screen as part of said subscription entry, with a selection of modules based on groupings of user interests.

18. The social networking system of claim 17 in which said modules further comprise a module for dating.

19. The social networking system of claim 18 in which said modules further comprise a plurality of module for customers interested in social interaction with customers with a common business or social interest.

20. The social networking system of claim 16 which further comprises a subscription selection screen with a plurality of subscription types to choose from, as part of said subscription entry.

21. A social networking system, comprising:
a web site available for interaction with customers from at least one WiFi router, said system comprising:
at least one database, with said database configured to store customer profile information;
a subscription page configured for sending to a new customer, with capability for the customer to enter profile and searching criteria information in a subscription entry;
a module selection screen as part of said subscription entry, with a selection of modules presented based on groupings of user interests;
a login page configured for sending to a signing-in customer, with capability to receive a username and password;
a WAN IP address detection module, for determining the WAN IP address of a signing-on user;
a searching algorithm which searches said at least one database and selects customers at the same WAN IP address as said signing-on user, and with searching criteria that match those of said signing-on user;
an output page listing subscribers presently using the same WAN IP Address as said signing-on user and having matching selection criteria as said signing-on user, with said output page listing selected profile information of those subscribers selected; and
a messaging system configured for a user to send a communication to a listed subscriber present at a subscriber's particular WAN IP Address, through said WiFi router and through said system.
